(19) United States
(12) Patent Application Publication
(10) Pub. No.: US 2021/0033331 A1
(43) Pub. Date: Feb. 4, 2021

(54) METHOD OF EXPEDITIOUSLY PROVIDING BOTTLES OF WATER AT A TEMPERATURE AND DESTINATION TO BE DETERMINED

(71) Applicant: William J. Lowe, Emmetsburg, IA (US)

(72) Inventor: William J. Lowe, Emmetsburg, IA (US)

(21) Appl. No.: 16/525,984

(22) Filed: Jul. 30, 2019

(51) Int. Cl. F25D 11/00

(52) U.S. Cl. CPC F25D 11/003

(57) ABSTRACT

A method of delivering bottled water at a predetermined temperature to a destination, which may be near a place where a natural disaster has occurred, using a trailer having a heating/cooling unit and a thermostat attached thereto. Placing bottled water inside the trailer while the inside of the trailer is at ambient temperatures, holding in reserve the bottled water inside the trailer at ambient temperatures until an order is received for such bottled water. When an order is received for such trailer load of bottled water to be delivered at a specified destination, the order also specifying whether the bottled water is to be delivered in a liquid or a frozen form, the cooling/heating unit is turned on and the thermostat is set, or preset, to a predetermined temperature so that the cooling/heating unit will move the bottled water temperature towards the predetermined temperature while the trailer is being towed towards the destination.

### TECHNICAL FIELD

This invention relates to a method of expeditiously providing bottles of water at a desired temperature and to a destination to be determined later.

### BACKGROUND

When natural disasters such as hurricanes, tornados, earthquakes, drinking water disasters, snow storms or the like, occur in the United States of America, typically the Federal Emergency Management Agency (FEMA), an agency of the United States Department of Homeland Security, orders supplies to be delivered to the site of such disaster. In almost all cases, bottled water is needed. Most often, in spring, summer and fall seasons, ice is also needed. Accordingly, FEMA typically places orders for (1) ice and (2) bottled water to be delivered to such disaster area in the aforementioned seasons. Bags of ice would typically be delivered in a refrigerated semi-trailer or other truck and bottles of water would typically be delivered in a non-refrigerated semi-trailer or other truck. The cost of separately delivering ice and water will almost always be expensive and the two products would likely not be delivered to the destination of the disaster at the same time as desired.

When such natural disaster occurs in a place where the temperature is below the freezing point of water, ice will typically not be needed, but bottled water needs to be delivered at a temperature above freezing so that it can be consumed immediately. If bottled water is delivered in an ordinary non-refrigerated semi-trailer truck in the wintertime, the bottles of water may be frozen and may be required to be moved to a heated area before it can be consumed by victims of such disaster.

The phrase “refrigerated semi-trailer” as is typically used in the industry, or “reefer”, is used herein to be synonymous with a semi-trailer having a “heating and cooling unit” thereon, which can cool the interior of the semi-trailer to as much as twenty five (25) degrees below zero Fahrenheit and can heat the interior of the semi-trailer to as much as 80 degrees above zero Fahrenheit, the desired temperature goal being set by a thermostat.

Accordingly, there is a need for a simple, easy and economical way to deliver water and/or ice to the site of a natural disaster.

### SUMMARY OF THE INVENTION

The present invention relates to a method of expeditiously providing bottles of water at a temperature and destination to be determined later by placing bottled water in a refrigerated semi-trailer at ambient temperatures so that the bottled water can be delivered as quickly as possible to a destination to be determined later and at a temperature to be determined later.

The invention relates to a method of delivering bottled water at a predetermined temperature to a destination, which may be near a place where a natural disaster has occurred, using a trailer having a heating/cooling unit and a thermostat attached thereto. Bottled water is placed inside the trailer while the inside of the trailer is at ambient temperatures, holding in reserve the bottled water inside the trailer at ambient temperatures until an order is received for such bottled water. When an order is received for such trailer load of bottled water to be delivered at a specified destination, the order also specifying whether the bottled water is to be delivered in a liquid or a frozen form, the cooling/heating unit is turned on and the thermostat is set, or preset, to a predetermined temperature so that the cooling/heating unit will move the bottled water temperature towards the predetermined temperature while the trailer is being towed towards the destination.

### BRIEF DESCRIPTION OF THE DRAWINGS

The above needs are at least partially met through provision of the method and apparatus described in the following detailed description, particularly when studied in conjunction with the drawings, wherein:

FIG. 1 shows a prior art way of loading a non-refrigerated semi-trailer with bottles of water using a fork lift;

FIG. 2 is an isometric view of a refrigerated semi-trailer with a cooling/heating unit attached to the front thereof;

FIG. 3 is a side view of a refrigerated semi-trailer similar to the one shown if FIG. 2;

FIG. 4 is a front view of the refrigerated semi-trailer shown in FIG. 3, showing a refrigeration unit attached thereto;

FIG. 5 is a rear view of the refrigerated semi-trailer shown in FIG. 3, showing the rear doors thereon, and would look like the semi-trailer of FIG. 1, if and when the doors of the FIG. 3 refrigerated semi-trailer are open;

FIG. 6 shows a fork lift with a load of bottled water on a pallet for loading into the refrigerated semi-trailer;

FIG. 7 shows a refrigerated semi-trailer with stacked pallet loads of bottled water filling the inside cavity of such refrigerated semi-trailer, air circulation arrows being shown to cool or heat the bottled water as desired; and

FIG. 8 shows a tractor trailer attached to the refrigerated semi-trailer for when it is desired to transport the refrigerated semi-trailer to a desired destination.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

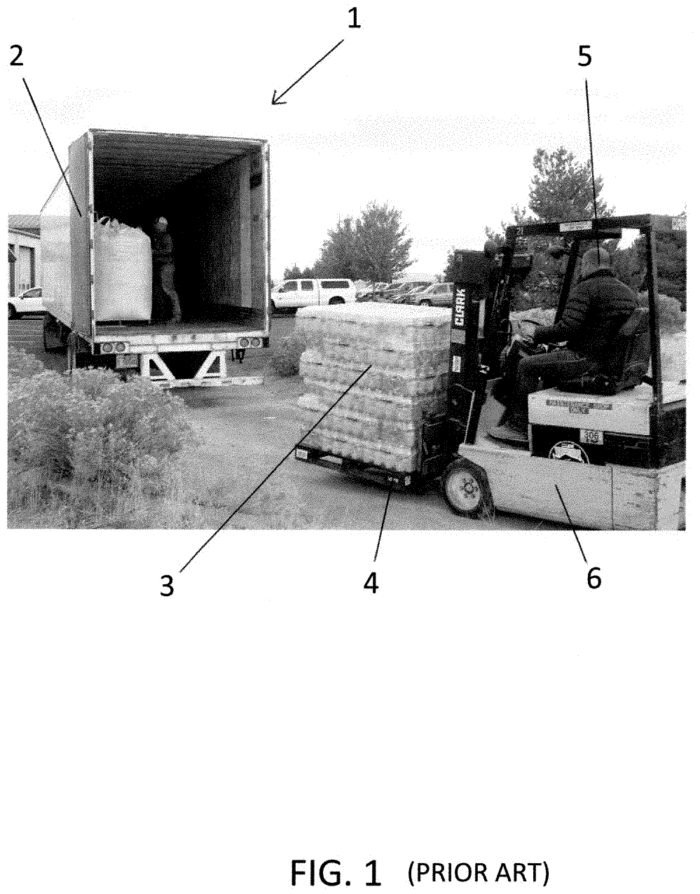

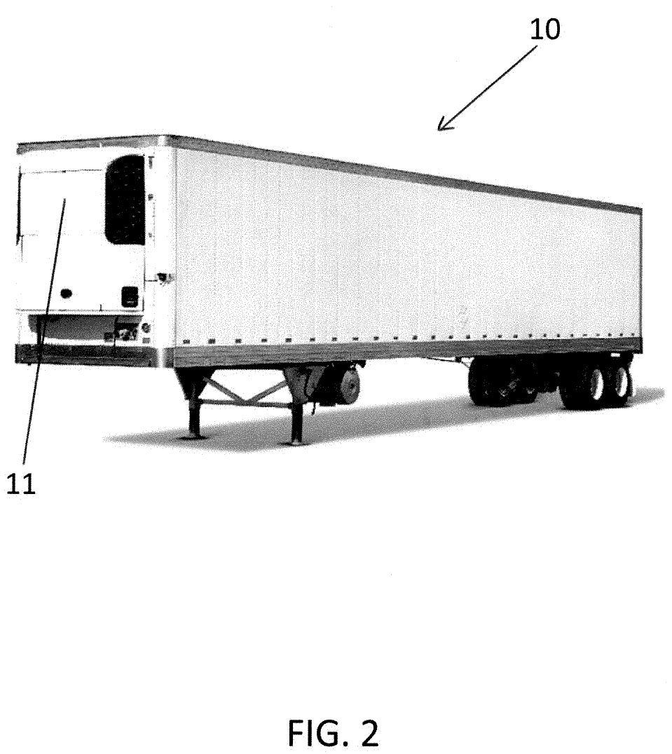

Referring now to the drawings, wherein like reference numerals indicate identical or similar parts throughout the several views, FIGS. 2-8 will be used to explain a preferred embodiment of the method of the present invention and how it is an improvement over the prior art shown in FIG. 1.

FIG. 1 shows a semi-trailer 1 with the doors 2 open in readiness to load cases of bottled water 3, loaded onto a pallet 4, by an operator 5 using a fork lift 6. Such semi-trailer 1 can be loaded with other supplies too, or the entire semi-trailer could be loaded with pallets of bottled water to be delivered to a site of a natural disaster, though in the broadest scope of this invention, it is not necessary use pallets.

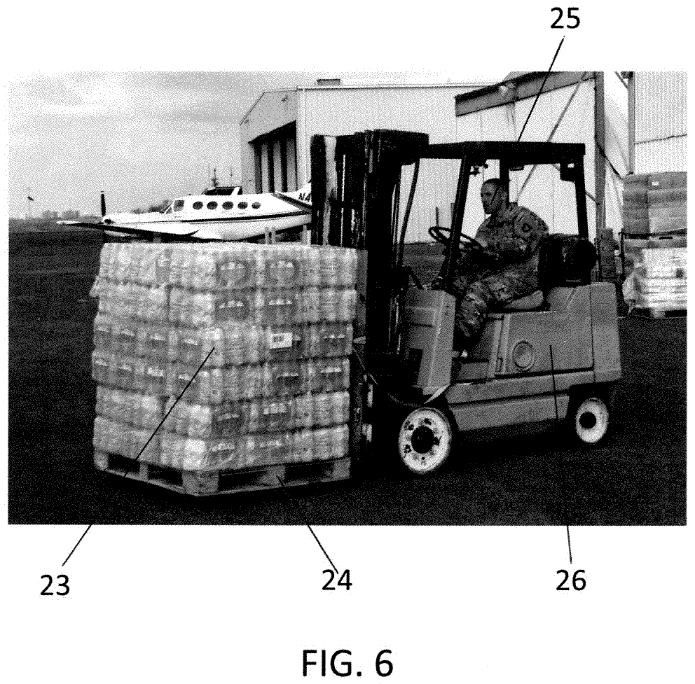

Referring now to FIG. 2, a refrigerated semi-trailer 10 (see definition above) is provided for being loaded (see FIG. 6) with cases of bottled water 23 on pallets 24 by an operator 25 using a fork lift 26.

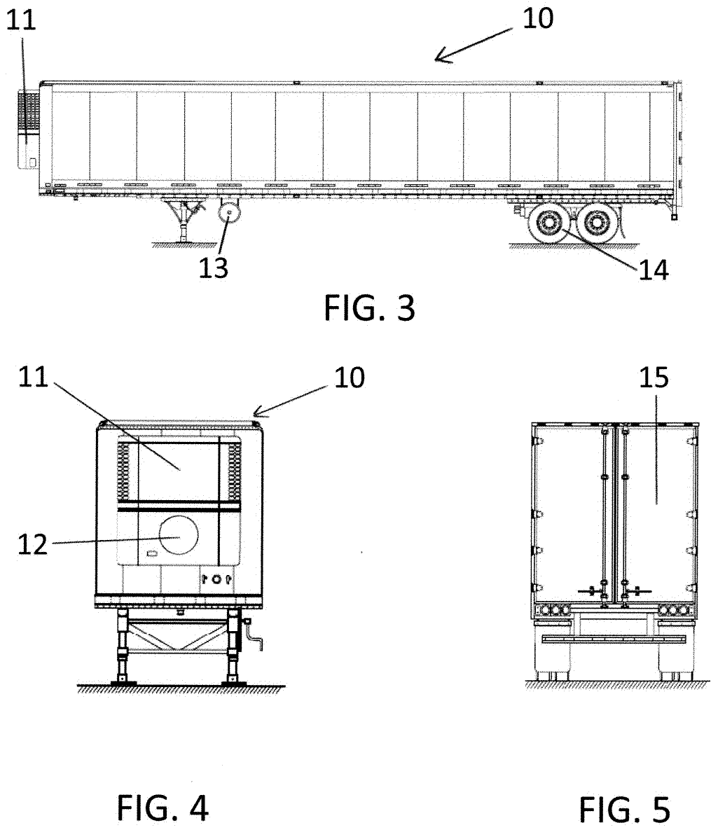

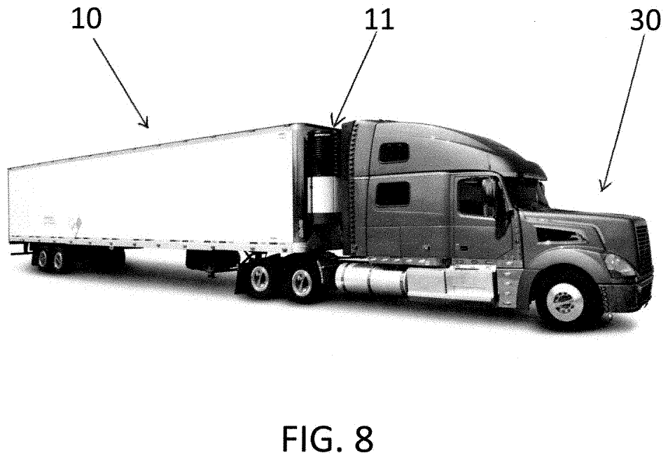

FIGS. 3-5 show the refrigerated semi-trailer 10 in more detail, including a thermostat 12 shown on the refrigeration unit 11, which thermostat can be used to set the desired ultimate temperature, for example, of between −25 degrees F. and +80 degrees F. as explained above. The location of the thermostat 12 is shown schematically on the unit 11, but the thermostat may be located anywhere on the refrigerated semi-trailer or even in a cab of a tractor trailer truck like the one shown in FIG. 8 and optionally connected wirelessly, or with wires. A fuel tank 13 for the refrigeration unit 11 is shown in FIG. 3, as are the wheels 14.

FIG. 4 shows the refrigeration unit 11 and FIG. 5 shows rear doors 15, that can be opened to load/unload and closed to seal the rear opening of the refrigerated semi-trailer 10.

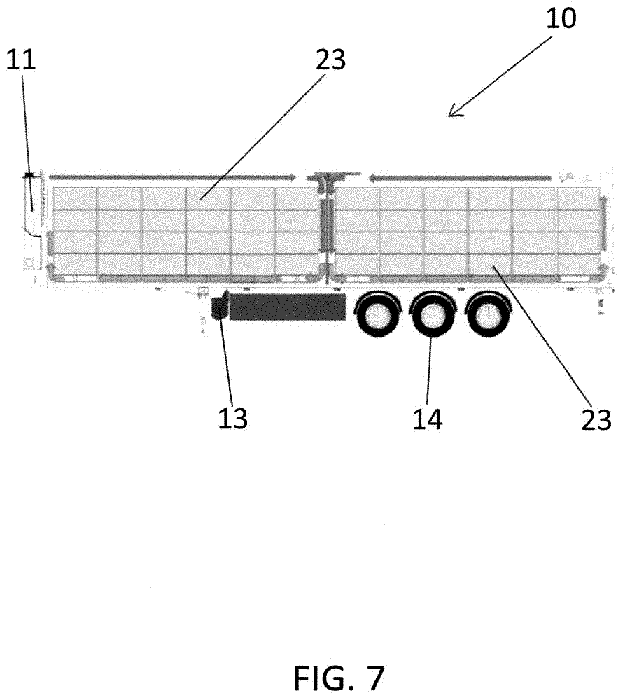

FIG. 7 shows stacks of cases of bottled water 23, with the refrigerated semi-trailer 10 being fully loaded, the arrows showing how the air circulates around the cases of bottled water 23 to cause the bottled water to either freeze or thaw as desired based on the setting of the thermostat 12.

In operation, the cases of water 23 would be loaded into the refrigerated semi-trailer 10, as shown in FIG. 7 as explained above. This refrigerated semi-trailer 10 would not have the refrigeration (heating/cooling) unit 11 on but would be just loaded in readiness for being transported to the site of a disaster as soon as possible after the disaster occurs. It would not be obvious to load a reefer with water and then let the reefer just sit there at ambient temperature. But by doing that as in the instant invention, the load will be available for dispatch immediately in an emergency. When a natural disaster occurs, FEMA, or other organization that typically orders ice or bottled water, will immediately place an order for cases of bottled water 23. If the order also requests that the bottled water be frozen, then the refrigeration unit 11 (a) would be turned on and (b) the thermostat 12 set (or preset) to its lowest temperature, say 25 degrees below zero F, (c) a tractor trailer 30 attached to the refrigerated semi-trailer 10 as shown in FIG. 8, and (d) a driver will drive the refrigerated semi-trailer 10 to the disaster site destination while the refrigeration unit is operating.

In most cases, the cases of bottled water will be frozen by the time the load of bottled water 23 arrive at the destination, but if they are not, the refrigeration unit 12, can be left on to complete the freezing process at the point of need for water and ice, noting that frozen bottles of water can fill a need for both ice and water. If water is desired more than ice, then a user can just let the water return to ambient temperature, which is assumed to be above freezing if both ice and water have been ordered.

In operation when water is ordered at a natural disaster at a place where ambient temperatures are below the freezing point of water, then once the cases of bottled water 23 have been fully loaded into the refrigerated semi-trailer 10 as shown in FIG. 7, the refrigerated semi-trailer 10 is in readiness to be towed to a destination where ambient temperatures are below the freezing point of water. It would not be obvious to load a reefer with water and then let the reefer just sit there at ambient temperature as in the present invention. But by doing that, the load will be available for dispatch immediately in an emergency. When an order for bottled water comes in, the thermostat 12 is set or preset to a desired temperature above the freezing point of water, which could be as high as 80 degrees F. using conventional “reefer” heating and cooling units. Then the tractor trailer truck 30 is attached to the refrigerated semi-trailer 10 as shown in FIG. 7 and the refrigerated semi-trailer 10 is towed to the destination while the refrigeration unit is at the same time being used to heat the bottles of water to keep them from freezing or unthaw them. That way the bottles of water can be immediately consumed by victims of such natural disaster (though ambient temperatures may be below the freezing point of water) when the refrigerated semi-trailer 10 and such victims are in the same designated location as the refrigerated semi-trailer 10.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept as expressed by the attached claims.

I claim:

1. A method of delivering bottled water at a predetermined temperature to a destination which may be near a place where a natural disaster has occurred, using a trailer having a heating/cooling unit and a thermostat attached thereto, the method comprising:
placing bottled water inside the trailer while the inside of the trailer is at ambient temperatures;
holding in reserve the bottled water inside the trailer at ambient temperatures until an order is received for such bottled water;
receiving an order for such trailer load of bottled water to be delivered at a specified destination, the order also specifying whether the bottled water is to be delivered in a liquid or a frozen form;
turning on the cooling/heating unit and setting or presetting the thermostat to a predetermined temperature so that the cooling/heating unit will move the bottled water temperature towards the predetermined temperature; and
towing the trailer to the specified destination while the cooling/heating unit is cooling or heating the inside of the trailer.

2. A method of delivering frozen bottled water to a destination which may be near a place where a natural disaster has occurred, comprising:
placing cases of bottled water on pallets;
loading the cases of bottled water on pallets into a semi-trailer having a refrigeration unit;
setting or presetting the refrigeration unit to a temperature that will be low enough to freeze water or confirming that the refrigeration unit is set to such temperature;
determining when the pallets of frozen bottled water are desired to be delivered to the destination;
turning on the refrigeration unit in a timely manner so that the bottles of water will be frozen by the time that the semi-trailer can be delivered to the destination;
attaching a semi-trailer tractor to the semi-trailer; and
driving the semi-trailer truck and semi-trailer to the destination while the refrigeration unit is running so that the bottled water is being frozen while it is being transported to the destination.

3. A method of delivering bottled water at a predetermined temperature to a destination which may be near a place where a natural disaster has occurred, comprising:
placing cases of bottled water on pallets;
loading the cases of bottled water on pallets into a semi-trailer having a refrigeration/heating unit;
setting or presetting a thermostat associated with the refrigeration/heating unit to a temperature that will be above the freezing point of water;
determining when the pallets of frozen bottled water are desired to be delivered to the destination;
turning on the refrigeration/heating unit in a timely manner so that the bottles of water will be at a temperature of above freezing by the time that the semi-trailer can be delivered to the destination;
attaching a semi-trailer tractor to the semi-trailer; and
driving the semi-trailer truck and semi-trailer to the destination while the refrigeration/heating unit is running so that the bottled water is set to be warmed to predetermined temperature while the bottled water is being transported to the destination.
